(19) United States
(12) Patent Application Publication
(10) Pub. No.: US 2005/0047510 A1
(43) Pub. Date: Mar. 3, 2005

(54) Data processing device for MPEG

(76) Inventors: Muneaki Yamaguchi, Inagi (JP); Junichi Kimura, Koganei (JP)

Correspondence Address: REED SMITH LLP, Suite 1400, 3110 Fairview Park Drive, Falls Church, VA, 22042, US

(21) Appl. No.: 10/886,710

(22) Filed: Jul. 9, 2004

(30) Foreign Application Priority Data
Aug. 27, 2003 (JP) 2003-302722
Jun. 16, 2004 (JP) 2004-178165

(51) Int. Cl. H04N 7/12

(52) U.S. Cl. 375/240.26; 375/240.2

(57) ABSTRACT

A data processing device which, in MPEC processing using a processor and a cache device connected to the processor, can accomplish fast and efficient processing by effectively utilizing the cache device is provided. The data processing device is provided with a main memory for storing data, a central processing unit (CPU) for accessing the main memory to execute MPEG encoding or decoding of data in accordance with an operation program, and a cache device connected to the CPU to store part of the data to be processed by the CPU, wherein the cache device has a first cache area for storing picture data decoded in the past and a second cache area for storing header information and DCT coefficients, and the CPU, in accessing the cache device, selects either of the first and second cache areas in accordance with relevant provisions in the operation program.

### CLAIM OF PRIORITY

The present application claims priority from Japanese applications JP 2003-302722 filed on Aug. 27, 2003 and JP 2004-178165 filed on Jun. 16, 2004, the contents of which are hereby incorporated by reference into this application.

### FIELD OF THE INVENTION

The present invention relates to data processing using a cache device, and more particularly to a data processing device which can be suitably applied to encoding and decoding by MPEG which encodes and decodes image signals.

### BACKGROUND OF THE INVENTION

Today, image utilizing systems realized by digital technology such as digital broadcasts, digital versatile discs (DVDs), personal computer handling pictures, and the like are rapidly developing. It is no exaggeration to say these new ways of using images have been made possible by the Moving Picture Experts Group (MPEG), which can significantly compress the quantity of image signal data while maintaining high picture quality.

In an MPEG process of encoding and decoding image signals, a frame constituting a motion picture to be encoded is divided into macroblocks, and encoding is processed in units of macroblocks. What constitute the cores of the process are Discrete Cosine Transform (DCT) and motion compensation. Steps of encoding including them are repeatedly performed macroblock by macroblock, and encoded data which constitute the final output are transmitted in a stream form. To the encoded data including DCT coefficients obtained by DCT is added a header in which information on the encoding method and the frames to be encoded are stored.

In a local decode during encoding, and in decoding after transmission, an inverse DCT process using the DCT coefficients and information referred to above is performed, and reference picture data is used for processing motion compensation in encoding and decoding. Whereas the data is stored in the main memory, a cache device which is small in capacity but permits high speed reading and writing is connected to a central processing unit (hereinafter referred to as processor) for temporary use to enable the processor to perform operations at high speed.

Among data processing devices which allow processing by a processor and MPEG processing to be accomplished by using the processor and a cache device connected to it, there are some in which the cache device is divided between the consecutive process by the processor and the repeat process by MPEG (for instance the Japanese Patent Application Laid-Open No 2001-256107).

### SUMMARY OF THE INVENTION

As stated above, various data is stored into the cache device during the MPEG process. However, as some data differ from others in property or the form of use, and the difference often invites obstruction of high speed reading or writing in the cache device.

The properties of data handled in MPEG operation processing will be described below.

What are stored in the header inserted into encoded data include information common to the pictures to be encoded, and the information and the like are accessed across different units of frame processing, i.e. a plurality of macroblocks that are processed, in encoding or decoding.

Next, whereas the DCT coefficients are calculated on a block-by-block basis and, with the result of calculation being included, encoding is performed macroblock by macroblock, the DCT coefficient for each block cannot be stored in the register of the processor. This is because the coefficient for each block has a volume of about 100 bytes, and therefore has to be once stored into the cache device before the process following DCT operation. Further in decoding, too, coded picture data obtained by an inverse DCT process need to be once stored into the cache device before an addition process that is to follow the inverse DCT process. However, after the process, no data on the cache device is accessed, and the same area is reused in the processing of the next macroblock.

As stated above, the header information, DCT coefficients and coded picture data are accessed many times during frame processing, the data is thereby used repeatedly, or the area is reused, resulting in a characteristic that no large area is required.

On the other hand, in the processing of predictive picture synthesis involving motion compensation, reference picture data which is picture data decoded in the past is read of a frame memory, and stored into a cache device. Then in the processing of predictive picture synthesis, basically different data is accessed for each macroblock. Therefore, the data that is read out is used only once and discarded after that.

It is highly probable for each reference area to be used only once during the process of encoding or decoding each macroblock. Further, because of the characteristics of pictures, it is also highly probable for the reference area and the macroblock currently being processed to be in the same position on the screen, and therefore it is highly likely for the reference area to differ from one macroblock to another that is processed. For this reason, accessing a reference area highly likely takes place in a very large address space. Furthermore, macroblocks in a frame are not always processed sequentially and, since the processing takes place macroblock by macroblock, it is necessary to perform processing to shift to the next line (horizontal scanning line) in a macroblock and, accordingly, sets of reference picture data are not consecutively arranged.

As stated above, reference area data has the characteristics that each set of such data is accessed and read out only once, has to be accessed in a very large address space, and is used only once.

One frame consists of 176×144 pixels in the Quarter Common Intermediate (QCIF) format used in cellular phones or the like or 640×480 pixels in the Video Graphic Array (VGA) format used in digital mobile terminals or the like. Assuming that MPEG code data have 1.5 bytes per pixel, capacities of 38 kilobytes and 450 kilobytes are required for the respective formats. The capacity of a packaged cache device at present is about 32 kilobytes or so for instance, which is less than the per-frame capacity mentioned above. Therefore, if the reference picture data and data for use in other processes, such as header information and DCT coefficients, are handled by the same cache device, the other data will be swept out of the cache device, and then will have to be retransferred from the main memory to the cache device when that data need to be referenced again. As a consequence, the overhead for the retransfer will be required, resulting in a loss of high speed in reading and writing.

An object of the present invention, therefore, is to provide a data processing device capable of fast and efficient MPEG processing using a processor and a cache device connected to the processor by effectively utilizing the cache device.

An outline of the invention intended to solve the problem noted above and disclosed in the present application is described as follows.

A data processing device according to the invention is provided with a main memory for storing data, a central processing unit (CPU) for accessing the main memory to execute data processing of MPEG encoding or decoding in accordance with an operation program, and a cache device connected to the CPU to store a part of the data to be processed by the CPU, wherein the cache device has a first cache area for storing picture data decoded in the past and a second cache area, and the CPU, in accessing the cache device, performs selection of the first and second cache areas in accordance with a relevant provision in the operation program.

In particular, reference pictures are read out of the first cache area during the MPEG processing, and header information and DCT coefficients are stored in the second cache area. Another feature of the data processing device according to the invention is that it may be provided with a main memory for storing data, a CPU for accessing the main memory to execute data processing in accordance with an operation program, a first cache memory connected to the CPU to store a part of the data to be processed by the CPU, a second cache memory connected to the CPU to store a part of the data to be processed by the CPU, and a selector for recording the data in either the first cache memory or the second cache memory.

It is preferable for the data processing device to additionally have an instruction cache memory. It can further be provided with a first selector matching a first cache memory and a second selector matching a second cache memory. In one example, selection signal lines for inputting a selection signal are connected to the first and second selectors. Switching-over between a first state in which the first selector lets the data pass and the second selector does not let the data pass and a second state in which the first selector does not let the data pass and the second selector lets the data pass is made possible with the selection signal. Complementary selection signals may be inputted into the first selector and the second selector. In MPEG picture processing for instance, the first cache memory may store picture data decoded in the past.

These and other objects and many of the attendant advantages of the invention will be readily appreciated, as the same becomes better understood by reference to the following detailed description when considered in connection with the accompanying drawings.

### BRIEF DESCRIPTION OF THE DRAWINGS

FIG. 1A is a block diagram of a decoder for explaining a data processing device that is a preferred embodiment of the present invention.

FIG. 1B is a schematic diagram for explaining data processing in the data processing device.

FIG. 2 is a block diagram for explaining the configuration of the data processing device shown in FIGS. 1A and 1B.

FIG. 3 is a block diagram for explaining a first embodiment of the invention.

FIG. 4A is a diagram showing a logical address in a processor according to the invention for explaining the state of logical memory space at the time of selection by a logical address.

FIGS. 4B is a diagram showing a logical address space according to the invention for explaining the state of logical memory space at the time of selection by a logical address.

FIG. 5 is a conceptual diagram for explaining conversion of a logical space into a physical space.

FIG. 6 is a flow chart of the operation to read out cache selection by address in the first embodiment.

FIG. 7 is another flow chart of the operation to read out cache selection by address in the first embodiment.

FIG. 8 is a flow chart of the operation to write in cache selection by address in the first embodiment.

FIG. 9 is another flow chart of the operation to write in cache selection by address in the first embodiment.

FIG. 10 is a conceptual diagram of data accessing in motion compensation for explaining a fifth embodiment of the invention.

FIG. 11 is a flow chart of the operation for motion compensation in the fifth embodiment.

FIG. 12 is a flow chart for explaining a sixth embodiment of the invention.

FIG. 13 is a schematic diagram for explaining an outline of the cache operation in the first embodiment.

FIG. 14 is a block diagram for explaining a second embodiment of the invention.

FIG. 15 is a block diagram for explaining a third embodiment of the invention.

FIG. 16 is a block diagram for explaining a fourth embodiment of the invention.

### DETAILED DESCRIPTION OF THE PREFERRED EMBODIMENTS

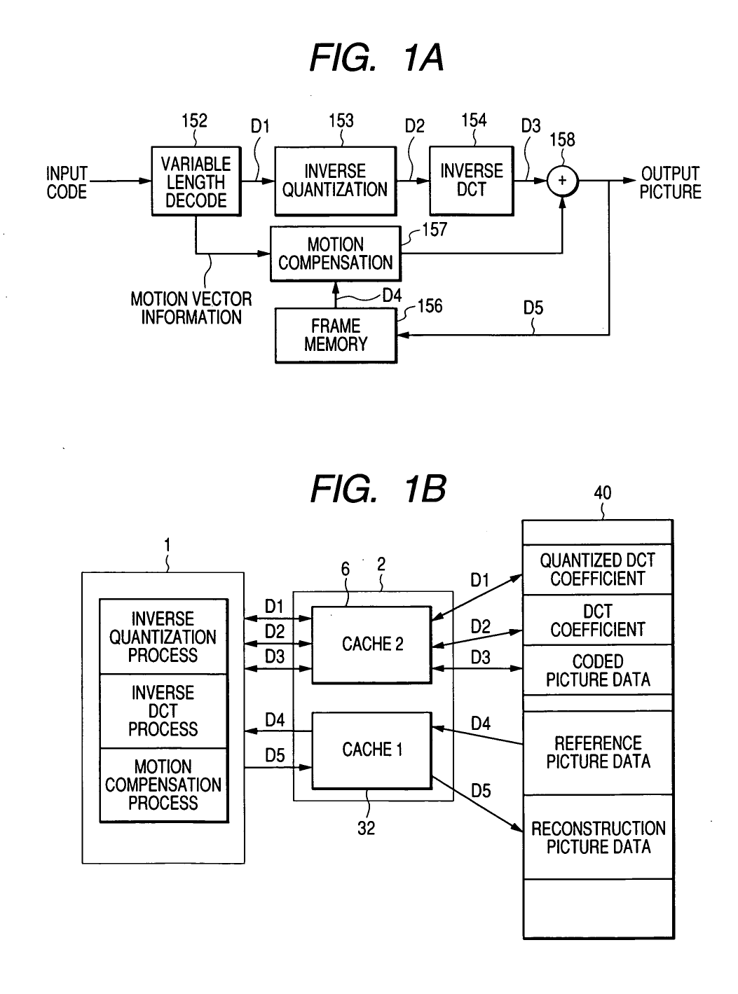

The data processing device according to the invention will be described in further detail below with reference to illustrated embodiments thereof. The same reference numerals in FIGS. 1-9 and FIGS. 13-16 denote either the same or similar elements.

First will be described encoding and decoding by MPEG. To begin with, according to MPEG, a block consisting of 8×8 pixels forms a small unit, and a macroblock consisting of six such blocks that comprise four for luminance and two for color difference signals forms a unit. A frame constituting a motion picture is divided into small areas each constituting a macroblock, and DCT computation is performed block by block while encoding takes place macroblock by macroblock.

Then, the configuration of a decoder to perform decoding is shown in FIG. 1A. The decoder can also be configured of software whose functions are to be executed on the CPU. It can also be configured of dedicated hardware. Alternatively, it is possible to compose it partly of software and partly of hardware. The decoder receives, as the input code, encoded data in a stream form following a header. The header is mounted, with information including the size of the original picture etc. as common information to the encoded data. These items of information are deciphered by a header analyzing process, and used for processing each macroblock.

The encoded data which has been received is inputted into a variable length decoder 152, and separated into a quantized DCT coefficient D1 and motion vector information. The quantized DCT coefficient D1 goes through an inverse quantizer 153 to become a DCT coefficient D2. The DCT coefficient D2 goes through an inverse DCT converter 154 to be decoded into coded picture data D3.

On the other hand, in a frame memory 156 is stored a frame preceding the currently processed frame, i.e. a reconstructed picture of the past. A motion compensating unit 157 determines the area to be referenced on the reconstructed picture according to motion picture information separated from the encoded data, reads reference picture data D4 from the area, and synthesizes a predicted macroblock picture. An adder 158 adds this predicted macroblock picture and the coded picture data D3 to output a decoded macroblock. Eventually a reconstructed picture is obtained from consecutive decoded macroblocks. To the frame memory 156 is sent reconstructed picture data D5 from the reconstructed picture, and the aforementioned picture of the preceding frame is formed.

An MPEG data process executed by a processor and a cache device connected to the processor in accordance with an operation program is shown in FIG. 1B. The MPEG data process by a processor 1 involves processes by the inverse quantizer 153, the inverse DCT converter 154 and the motion compensating unit 157. Further in the MPEG process, the quantized DCT coefficient D1, the DCT coefficient D2, the coded picture data D3, the reference picture data D4 and the reconstructed picture data D5 are stored in a main memory 40. Though not shown, information common to frames and the like are also stored in the main memory 40.

According to the invention, a cache device 2 is provided with a first cache area (hereinafter simply referred to as first cache: cache 1) 32 and a second cache area (hereinafter simply referred to as second cache: cache 2) 6. The area into or out of which the quantized DCT coefficient D1, the DCT coefficient D2 and the coded picture data D3 are written or read is immediately reused after they are written into it. For this reason, the second cache 6 is used for writing and reading the quantized DCT coefficient D1, the DCT coefficient D2 and the coded picture data D3. The second cache 6 is also used for common information that is commonly and repeatedly used for the processing of each macroblock.

On the other hand, the first cache 32 is used for reading the reference picture data D4 and writing the reconstructed picture data D5, both used only once.

As described above, the invention is characterized in that reference picture data, which is picture data reconstructed in the past, accessed only once and used only once, is stored in an area dedicated to it and other data which, such as header information and DCT coefficients, is repeatedly used by accessing a plurality of times and data whose area is reused after they are accessed are stored in a different area.

Incidentally, the programmer stating the MPEF processing program can state the codes during the preparation of processing codes while consciously distinguishing the two sequences of data from each other. Since it is determined according to the way of MPEG processing whether or not to reuse each set of data under processing and accordingly is obvious, it can be realized, at the stage of program preparation by the programmer, by the designation of the cache area to be used according to a difference in memory address (first embodiment), the designation of a cache area using a control register (second embodiment), or the designation of a cache area by an alteration in the instruction used by the processor (third embodiment). These ways of designating a cache area constitute provisions in the operation program for cache selection.

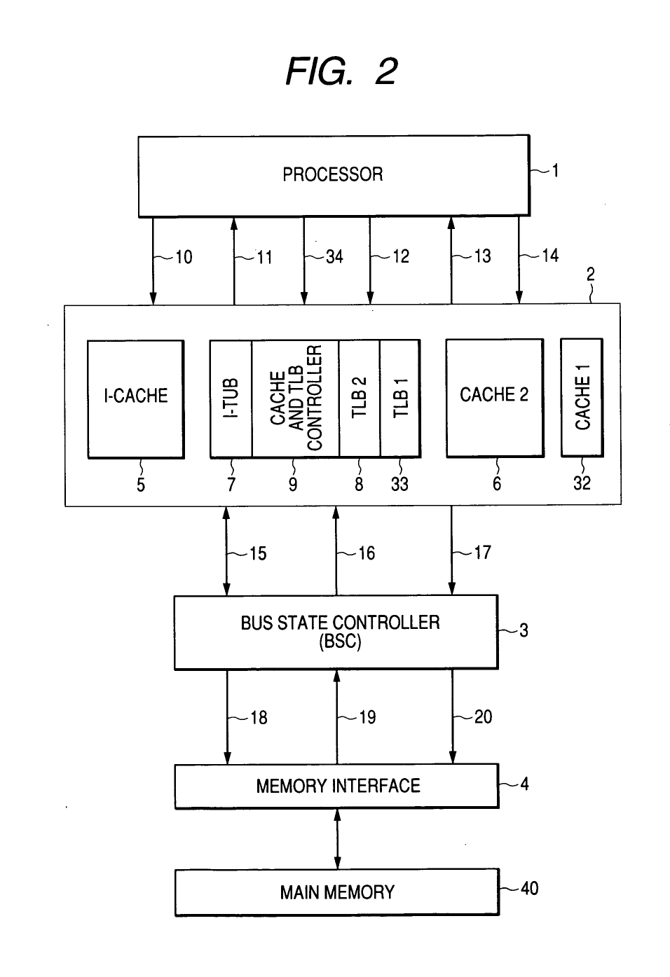

FIG. 2 shows the data processing device for MPEG data processing shown in FIGS. 1A and 1B. The data processing device of FIG. 2 comprises the processor 1, the cache device 2, a bus state controller (BSC) 3, a memory interface 4, and the main memory 40 connected to the memory interface 4.

The cache device 2 has a configuration in which the first cache 32 and a first cache Translation Lookaside Buffer (TLB) 33 are added to usual parts of an instruction cache 5, a second cache 6, an instruction cache TLB 7, a second cache TLB 8 and a cache TLB controller 9. Incidentally, the TLB functions as a table in which addresses for accessing the caches are stored.

The processor 1 and the cache device 2 are connected by a cache selector control line 34 in addition to an address line 10 for instruction use, a data line 11 for instruction use, an address line 12 for data use, a read data line 13 for data use and a write data line 14 for data use. Further, the cache device 2 and the bus state controller 3 are connected by an address line 15, a data line 16 for read use and a data line 17 for write use, and the bus state controller 3 and the memory interface 4 are connected by an address line 18, a data line 19 for read use and a data line 20 for write use.

(Embodiments)

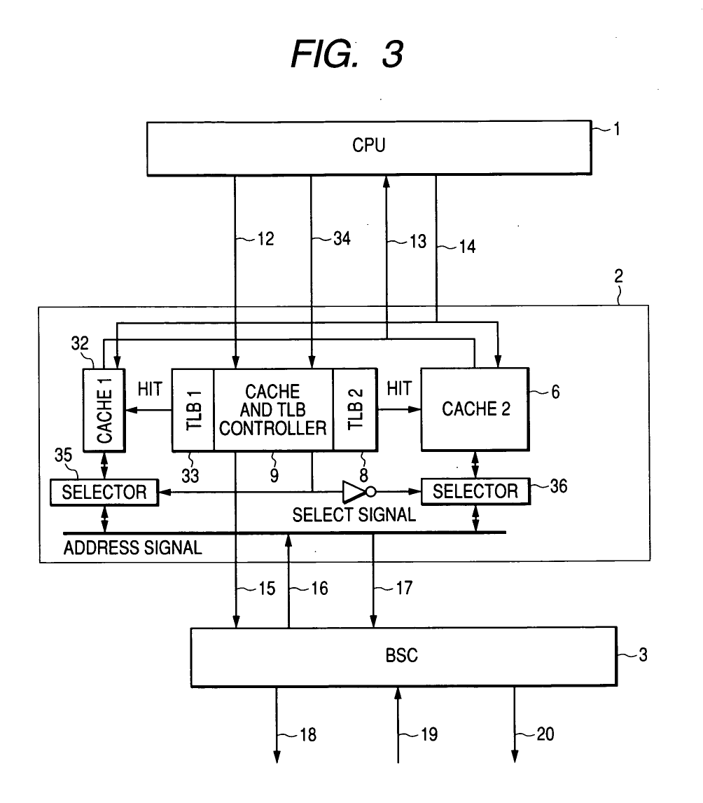

A first embodiment of the data processing device according to the invention will be described below with reference to FIGS. 3-9 and FIG. 13. In this embodiment, choice between the second cache 6 and the first cache 32 uses the address of data. As will be described in more detail afterwards, the program is so designed as to allocate part of the address of data for cache selection, and the state of the cache selection signal is set on a cache selector control line 34 according to that address. In this way, part of the address of data is made a provision in the operation program.

FIG. 3 is a schematic diagram illustrating the actions of caches. Explanation of the instruction cache will be omitted. FIG. 3 illustrates the mutual connection among the second cache 6, the first cache 32, the second cache TLB 8, the first cache TLB 33 and the cache TLB controller 9 shown in FIG. 2 with two selectors 35 and 36 being added.

The processor 1 and the cache device 2 connected to it perform the following data accessing actions.

First will be described how a DCT coefficient is written in before a DCT process. As described above, this action is to write a DCT coefficient into the second cache 6.

At a data write instruction, the processor 1 supplies the address of writing into the cache device 2 to the address line 12 for data use and the DCT coefficient to the write data line 14 for data use, sets the cache selection signal to the cache device 2 in a state to select the second cache 6, and supplies the signal to the cache selector control line 34. The cache TLB controller 9 performs an action to write into the second cache 6 in accordance with the signal from the cache selector control line 34.

Next will be described how reading out of a DCT coefficient is processed. The DCT coefficient is held on the second cache 6 as stated above. At a data read instruction, the processor 1 supplies the address of reading out of the cache device 2 to the address line 12 for data use, sets the cache selection signal to the cache device 2 in a state to select the second cache 6, and supplies the signal to the cache selector control line 34. The cache TLB controller 9 performs an action to read out of the second cache 6 in accordance with the signal from the cache selector control line 34, and the DCT coefficient that has been read out is stored into a register (not shown) within the processor 1.

Now will be described how coded picture data is written in after the DCT process. As described above, this action is to write coded picture data into the second cache 6.

According to a data write instruction, the processor 1 supplies the address of writing into the cache device 2 to the address line 12 for data use and the coded picture data to the write data line 14 for data use, sets the cache selection signal to the cache device 2 in a state to select the second cache 6, and supplies the signal to the cache selector control line 34. The cache TLB controller 9 performs an action to write into the second cache 6 in accordance with the signal from the cache selector control line 34.

Next will be described how coded picture data is read out. The coded picture data, which are generated by a DCT process, is held on the second cache 6 as stated above. According to a data read instruction, the processor 1 supplies the address of reading out of the cache device 2 to the address line 12 for data use, sets the cache selection signal to the cache device 2 in a state to select the second cache 6, and supplies the signal to the cache selector control line 34. The cache TLB controller 9 performs an action to read out of the second cache 6 in accordance with the signal from the cache selector control line 34, and the data that have been read out is stored into a register (not shown) within the processor 1.

Now will be described how reference picture data in the frame memory are read out. Although it was stated above that the first cache 32 would be used for reference picture data, the second cache 6 can be used depending on the state of the reference picture data. Cache areas are controlled in units referred to as lines. Therefore, if an end of reference picture data uses the same line as another data area, they may be stored in the second cache 6. This is the case in which the second cache 6 is used for reference picture data. The case in which the second cache 6 may be used in addition to the first cache 32 will be taken up in the following description.

According to a data read instruction, the processor 1 supplies the address of reading out of the cache device 2 to the address line 12 for data use, sets the cache selection signal to the cache device 2 in a state to select the first cache 32, and supplies the signal to the cache selector control line 34. The cache TLB controller 9, in accordance with the signal on the cache selector control line 34, checks whether or not there is requested data of the specified address on either the first cache 32 or the second cache 6 and, if there is, supplies the reference picture data to the read data line 13 for data use. In this case, since the same data is not present on both the second cache 6 and the first cache 32, there will be no data clash.

On the other hand, if the address is found on neither cache, the cache TLB controller 9 will supply the read address to the address line 15, reads the reference picture data out of the main memory 40 via the bus state controller 3, and stores them into the first cache 32. On that occasion, the selector 35 lets the data pass in accordance with the cache selector control line 34 supplied via the cache TLB controller 9, and the selector 36 prevents the data from passing. The read-out data is delivered to the processor 1 via the read data line 13 for data use.

Next will be described how picture frame data is written in.

Picture frame data generated by adding the coded picture data and the reference picture data are written into the first cache 32, because they are not to be reused immediately. According to a data write instruction, the processor 1 supplies the address of writing into the cache device 2 to the address line 12 for data use and the write data to the write data line 14 for data use, sets the cache selection signal to the cache device 2 in a state to select the first cache 32, and supplies the signal to the cache selector control line 34. The cache TLB controller 9 checks whether or not there is requested data of the specified address on the first cache 32 and, if there is, stores the data into cache 32. On the other hand, if the address is not found on the first cache 32, the data will be stored into the main memory 40 via the selector 35 and the data line, and furthermore the bus state controller 3.

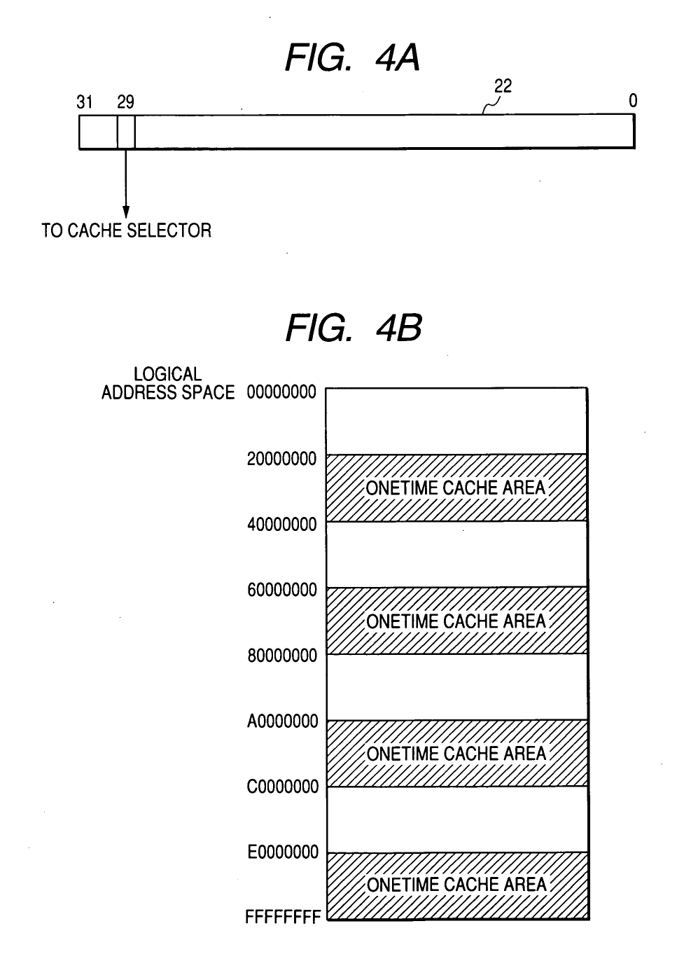

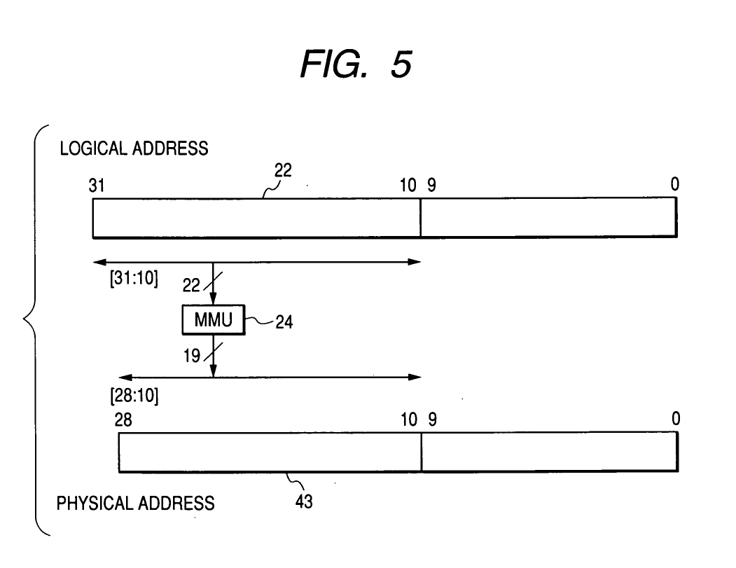

Next will be described, with reference to FIGS. 4(a), 4(b), and FIG. 5, how the second cache 6 or the first cache 32 is selected in this embodiment of the invention, i.e. provisions for selection in the operation program.

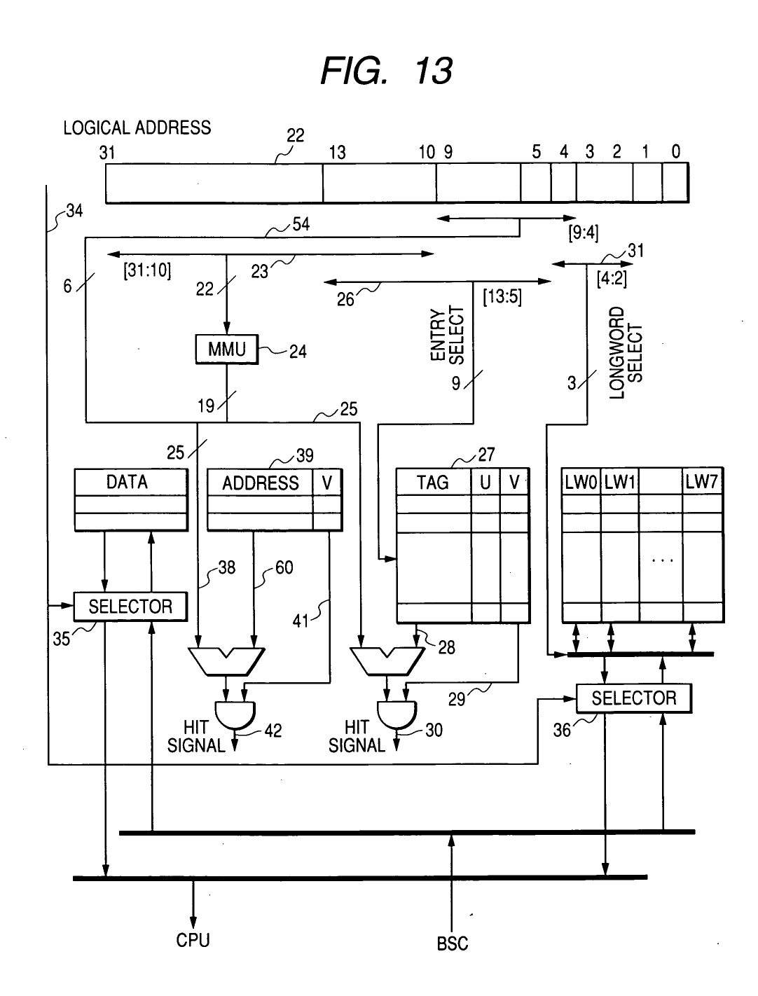

In the examples shown in FIGS. 4A, 4B, and FIG. 5, the processor 1, using a logical address space, performs conversion of a logical address into a physical address by using a Memory Management Unit (MMU) or the like, and thereby accesses the cache device 2 and the main memory 40. FIG. 4A shows a case in which the 29th bit of the logical address 22 of the processor 1 is allocated for cache selection. As a result, four logical spaces for accessing the first cache (ONETIME cache areas) are positioned in the 32 bit memory space as show in FIG. 4B. The cache selection at the 29th bit of FIG. 4A is connected to the cache selector control line 34 shown in FIG. 13, and the cache selection is carried out, accompanied by the following action.

FIG. 13 shows a case in which is used a direct map type data cache of a logical address of 32 bits, a physical address of 29 bits, a word size of 32 bits and a line size of 32 bytes and a one-time read/write cache of a line size of 8 bytes. The processor 1 accesses data by using the logical address 22 and the cache selector control line 34. The 22 bits 23 from the 10th bit through the 31st bit of the logical address are mapped on the 19 most significant bits 25 of the physical address in an MMU 24.

First on the one-time read/write cache side, the value of six bits 54 from the fourth to ninth bits of the logical address and the 19 bits 25 of the output of the MMU 24 are put together into an address value 38. According to the logical sum of the output of comparison of this address with the address 60 on an address array 39 of the one-time read/write cache and a V bit 41, a hit signal 42 on the one-time read/write cache is supplied. The word position on a line (eight bytes) on the cache is determined by two bits from the second bit to the third bit of the logical address, and is supplied as data.

On the data cache side, entries in an address array 27 and line positions on the cache are determined according to the values of nine bits 26 from the fifth bit to the 13th bit of the logical address, and the 19 most significant bits 28 of the physical address stored in the cache are taken out. According to the logical sum of the result of comparison of these 19 bits with 19 bits of the output of the MMU and a V bit 29 on the address array 27, a hit signal 30 is supplied. The position on a line (32 bytes) on the cache is determined by three bits from the second bit to the fourth bit of the logical address, and is supplied as data.

Therefore, if the programmer selects and accesses a logical memory space for accessing the first cache, for instance A0001000 or the like in the case of FIG. 4B, access to a memory using the first cache 32 is made possible.

As shown in FIG. 5, whereas the more significant bits of the logical address 22 of the processor are mapped by the MMU 24 at a physical address 43, the 29th bit then is taken out, and a cache selection signal is supplied to the cache selector control line 34 shown in FIG. 3. Thus when the 29th bit is 1, the cache selector control signal on the cache selector control line becomes ON, and when the bit is 0, the signal becomes OFF.

While cases in which the processor uses a logical address was described with reference to FIGS. 4A, 4B, and FIG. 5, where the processor uses no MMU, it directly accesses by a physical address, and accordingly cache selection is allocated to one bit of the physical address. Though there is no action via an MMU, the cache selection signal on the cache selector control-line is turned ON or OFF according to the allocated bit.

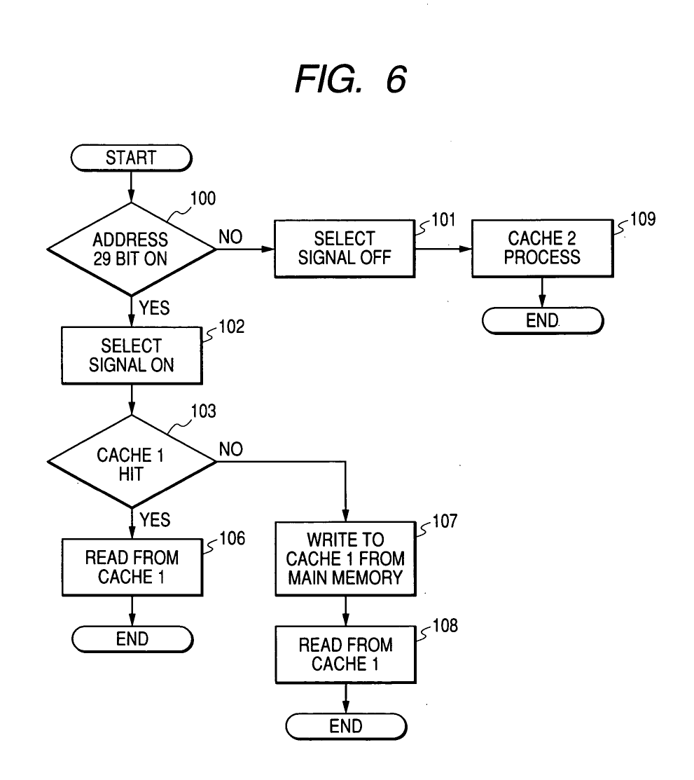

The selecting operation was described on the basis of the arrangement and connection of circuits with reference to FIG. 3 and on the basis of the logical address and the physical address with reference to FIGS. 4A, 4B, and FIG. 5. Next, the overall operation will be described with reference to flow charts presented as FIG. 6 through FIG. 9.

FIG. 6 is a flow chart of the read operation in this embodiment. First, when the processor 1 has initiated a data read instruction action, the 29th bit of the address is checked (100); if it is not ON, the cache selection signal (select signal) will be turned OFF (101), and a second cache action 109 will be performed. If the 29th bit is ON, the cache selection signal will be turned ON (102), and the first cache 32 is checked as to whether or not it is hit (103). If it is hit, reference pixel data will be read out of the first cache 32, and transferred to the processor 1 (106). If it is not hit, the data will be written from the main memory 40 into the first cache 32 (107) and the reference pixel data will be further read and transferred to the processor 1 (108).

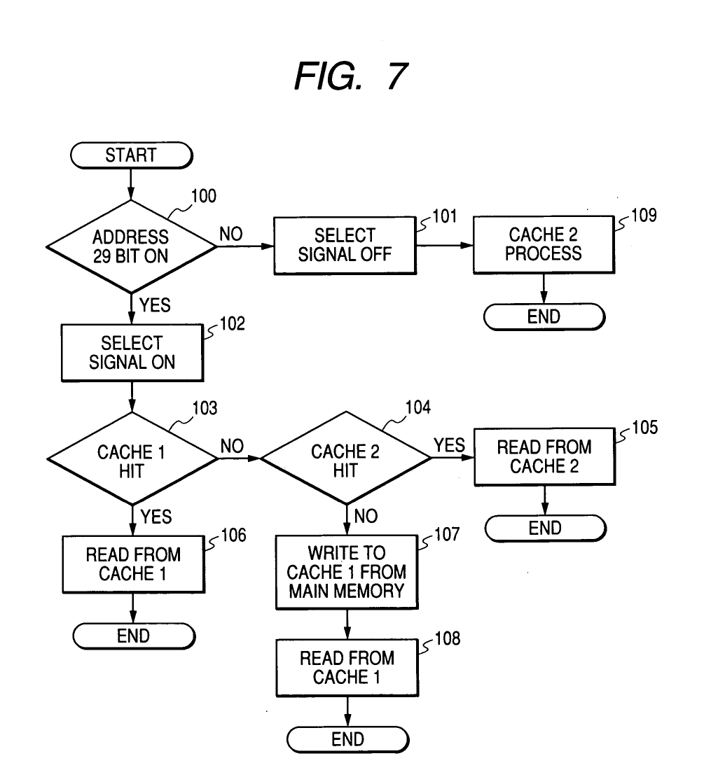

Incidentally, it was already stated that the reference pixel data could be stored into the second cache 6 in some cases. FIG. 7 charts the flow of reading in such a case. In the flow chart of FIG. 7, step 104 and step 105 are added to the flow chart of FIG. 6. When it is checked whether or not the second cache 6 is hit (104), if it is hit, the reference pixel data will be read out of the second cache 6 and transferred to the processor 1 (105). If it is not hit, the data will be written from the main memory 40 into the first cache 32 (107), and those reference pixel data will be further read and transferred to the processor 1 (108).

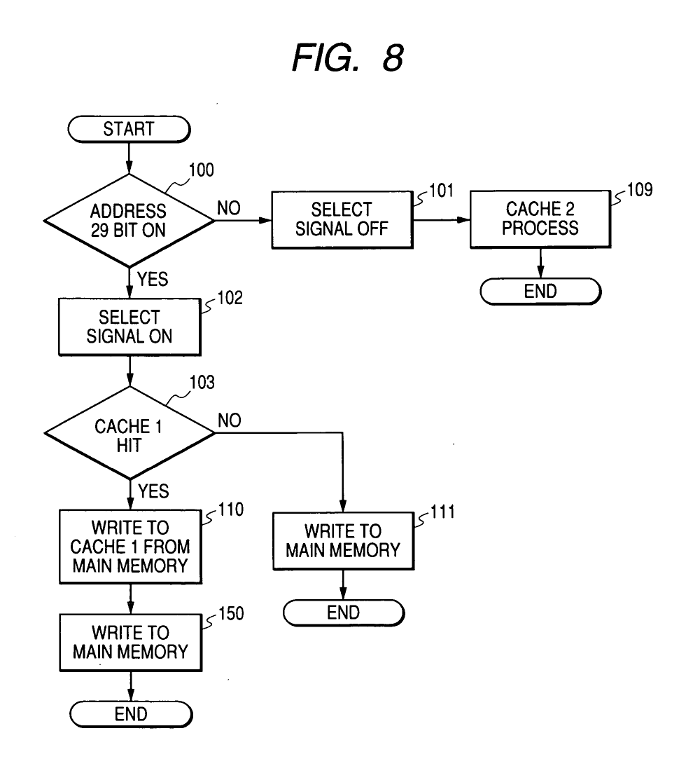

FIG. 8 is a flow chart of the write operation in this embodiment. First, when the processor 1 has initiated a data write instruction action, the 29th bit of the address is checked (100); if it is not ON, the cache selection signal (select signal) will be turned OFF (101), and the second cache action 109 will be performed. If the 29th bit is ON, the cache selection signal will be turned ON (102), and the first cache 32 is checked as to whether or not it is hit (103). If it is not hit, data from the processor 1 will be transferred and written into the main memory 40 (111). If the first cache 32 is hit, data will be written into the first cache 32 (110), and later written into the main memory 40 (150).

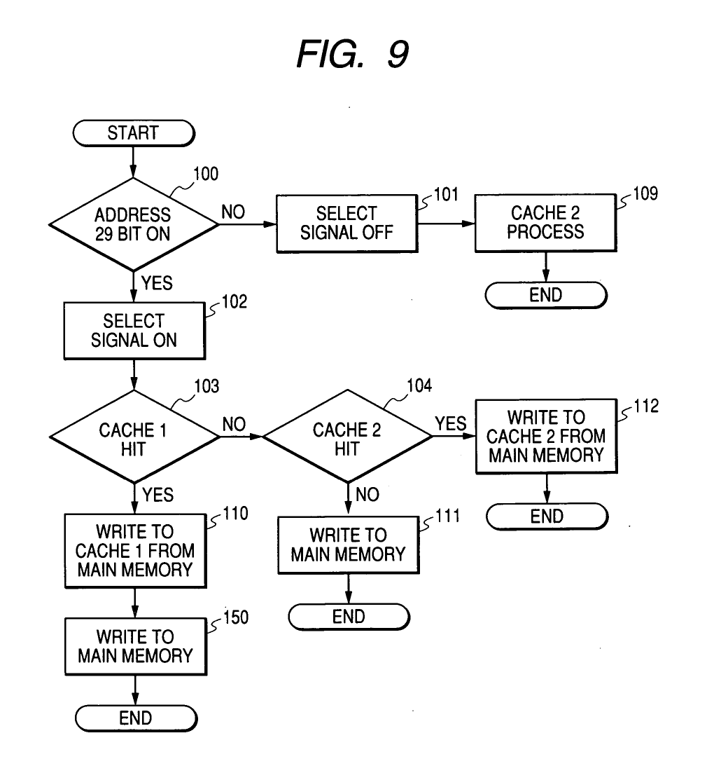

FIG. 9 is a flow chart of the read operation to enable reference pixel data to be written into the second cache 6. In FIG. 9, step 104 and step 112 are added to the flow chart of FIG. 8. When it is checked whether or not the first cache 32 is hit (103), if it is not hit, whether or not the second cache 6 will be checked (104) and, if it is hit, data from the processor 1 will be stored, i.e. written, into the second cache 32 (112) or, if it is not hit, data from the processor 1 will be transferred and written into the main memory 40 (111).

As described above, in the cache device in this embodiment of the invention, reference picture data which is used only once and other data which is repeatedly used by accessing a plurality of times and data whose area is repeatedly used are stored in different areas. This makes it possible to avoid the inconvenience that other data is swept out of the cache device and, when it is to be referenced again, retransferred from the main memory to the cache device. Thus has been successfully realized a data processing device which enables the cache device to be effectively utilized and fast and efficient MPEG processing to be accomplished.

A second embodiment of the present invention enables the programmer to select either the first cache 32 or the second cache 6 by utilizing an alteration in the contents of a cache control register included in the processor 1. An alteration in the contents of the cache control register, i.e. the condition of, selection, is stored, and the provision for selection in the operation program is thereby formulated.

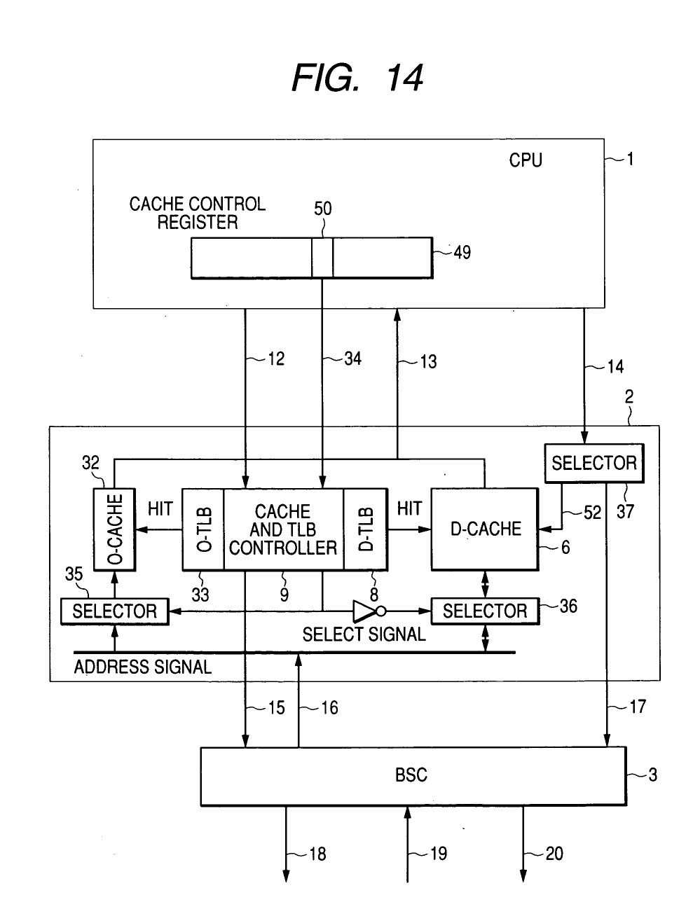

This embodiment will now be described with reference to FIG. 14. FIG. 14 is a schematic diagram outlining the cache operation in this embodiment. The instruction cache is not shown therein because it is not referred to in the description. The data processing device consists of the processor 1, the cache device 2 and the bus state controller 3, and the processor 1 comprises a cache control register 49 and other elements. The cache control register 49 is a register for selecting the ON or OFF state of the cache device or the mode of the cache device. The cache device 2 comprises a data cache 6, a one-time read/write cache 32, a data cache TLB 8, a one-time read/write cache TLB 33, a cache TLB controller 9 and three selectors 35, 36 and 37. The processor 1 and the cache device 2 are connected by an address line 12 for data use, a read data line 13 for data use, a write data line 14 for data use, and a cache selector control line 34, and the cache device 2 and the bus state controller 3 are connected by an address line 15, a read data line 16 and a write data line 17. Data accessing actions by the processor 1 and the cache device 2 are described below.

The processor 1 involves the cache control register 49 as stated above, and it is possible to alter the state of cache use by having the processor 1 vary the contents of the cache control register 49. Thus, a cache selection bit 50 is provided in the cache control register. As the cache selection signal is OFF when the cache selection bit 50 is 0 and the cache selection signal is ON when the cache selection bit 50 is 1, cache selection is made possible.

A third embodiment of the present invention enables the programmer to select either the second cache or the first cache by altering the instruction to be used by the processor 1. The alteration of the instruction is made a provision in the operation program.

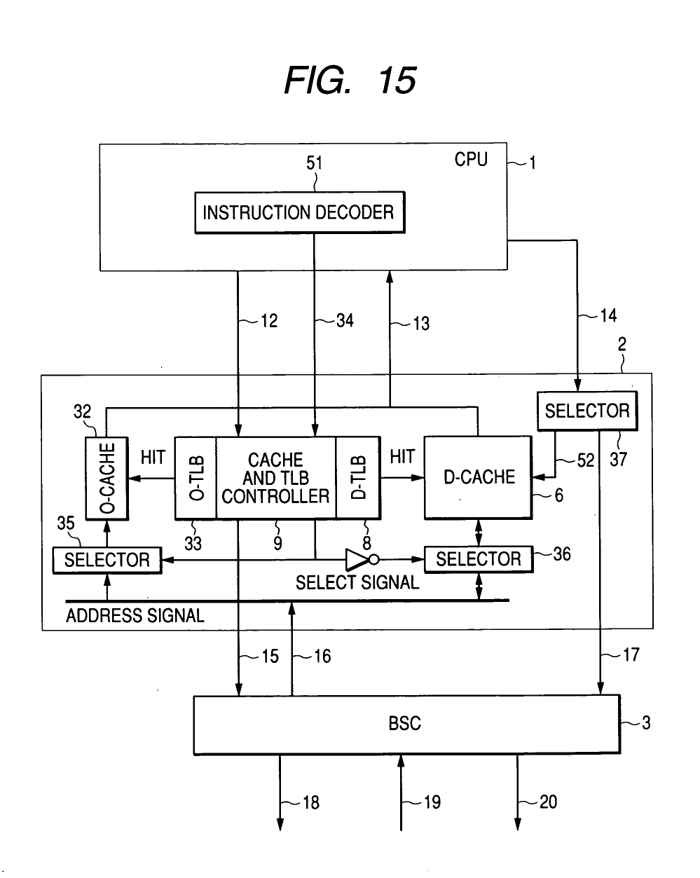

FIG. 15 is a schematic diagram outlining the cache operation in this embodiment. The instruction cache is not shown therein because it is not referred to in the description. The data processing device consists of the processor 1, the cache device 2 and the bus state controller 3, and the processor 1 comprises an instruction decoder 51 and other elements. The cache device 2 comprises the data cache 6, the one-time read/write cache 32, the data cache TLB 8, the one-time read/write cache TLB 33, the cache TLB controller 9 and the three selectors 35, 36 and 37. The processor 1 and the cache device 2 are connected by the address line 12 for data use, the read data line 13 for data use, the write data line 14 for data use, and the cache selector control line 34, and the cache device 2 and the bus state controller 3 are connected by the address line 15, the read data line 16 and the write data line 17. Data accessing actions by the processor 1 and the cache device 2 are described below.

The processor 1 involves the instruction decoder 51 which analyzes the instruction to be executed by the processor 1. If the result of analysis reveals that the instruction is a data access instruction for which the second cache 6 is to be used, the cache selection signal 34 will be OFF, or the instruction is a data access instruction for which the first cache 32 is to be used, the cache selection signal 34 will be ON.

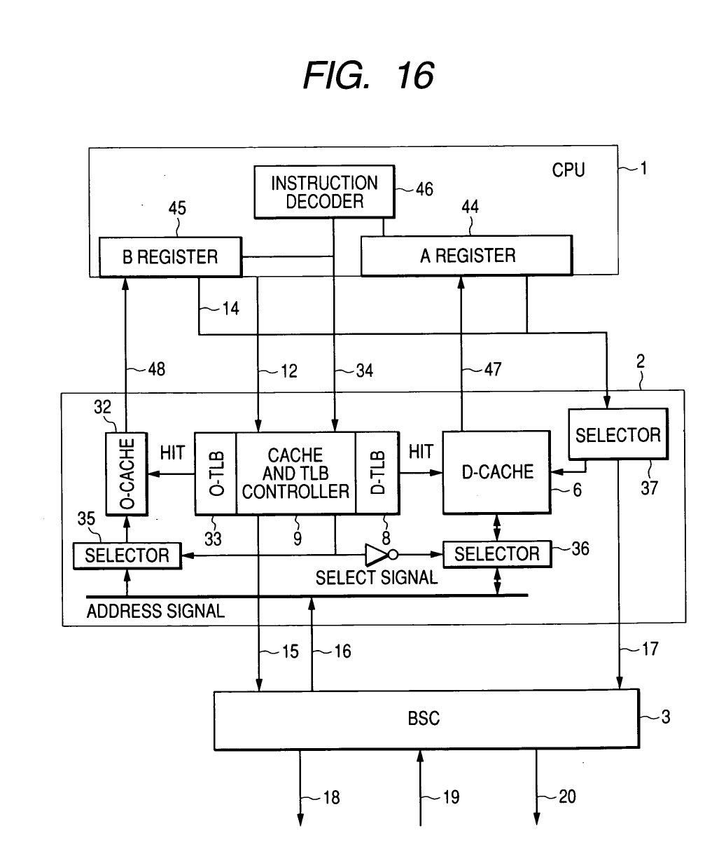

A fourth embodiment of the present invention enables the programmer to make cache selection by selecting the register to be used. FIG. 16 is a schematic diagram outlining the cache operation in this embodiment. The instruction cache is not shown therein because it is not referred to in the description. The data processing device consists of the processor 1, the cache device 2 and the bus state controller 3, and the processor 1 comprises an instruction decoder 46, an A register group 44, a B register group 45 and other elements. The cache device 2 comprises the data cache 6, the one-time read/write cache 32, the data cache TLB 8, the one-time read/write cache TLB 33, the cache TLB controller 9 and three selectors 35, 36 and 37. The processor 1 and the cache device 2 are connected by the address line 12 for data use, the read data line 13 for data use, the write data line 14 for data use, and the cache selector control line 33, and the cache device 2 and the bus state controller 3 are connected by the address line 15, the read data line 16 and the write data line 17. Data accessing actions by the processor 1 and the cache device 2 will be described below.

The instruction to be executed by the processor 1 is analyzed by the instruction decoder 46. As a result of the analysis, an enable signal is supplied to the A register group 44 to be used. An enable signal to the B register group 45 is also connected to the cache selector control signal 34. For this reason, in data accessing which utilizes the A register group 44 using the second cache, the cache selector control signal 34 is OFF, and in data accessing which utilizes the B register group 45, the cache selector control signal 34 is ON.

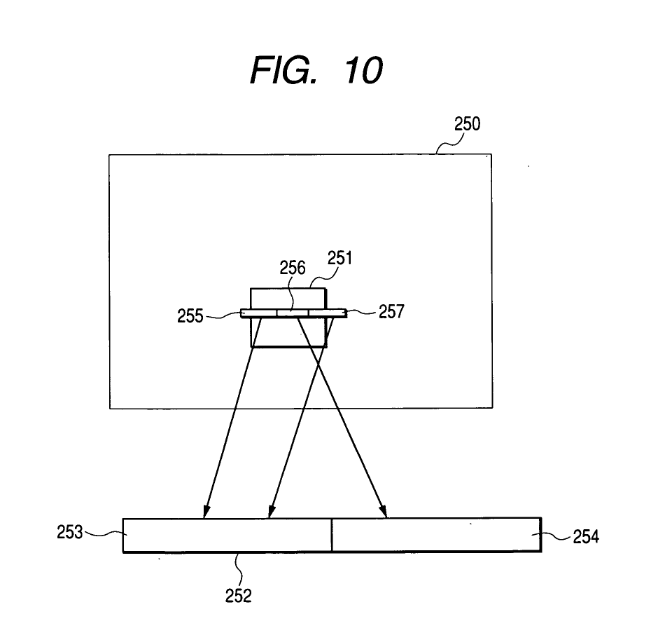

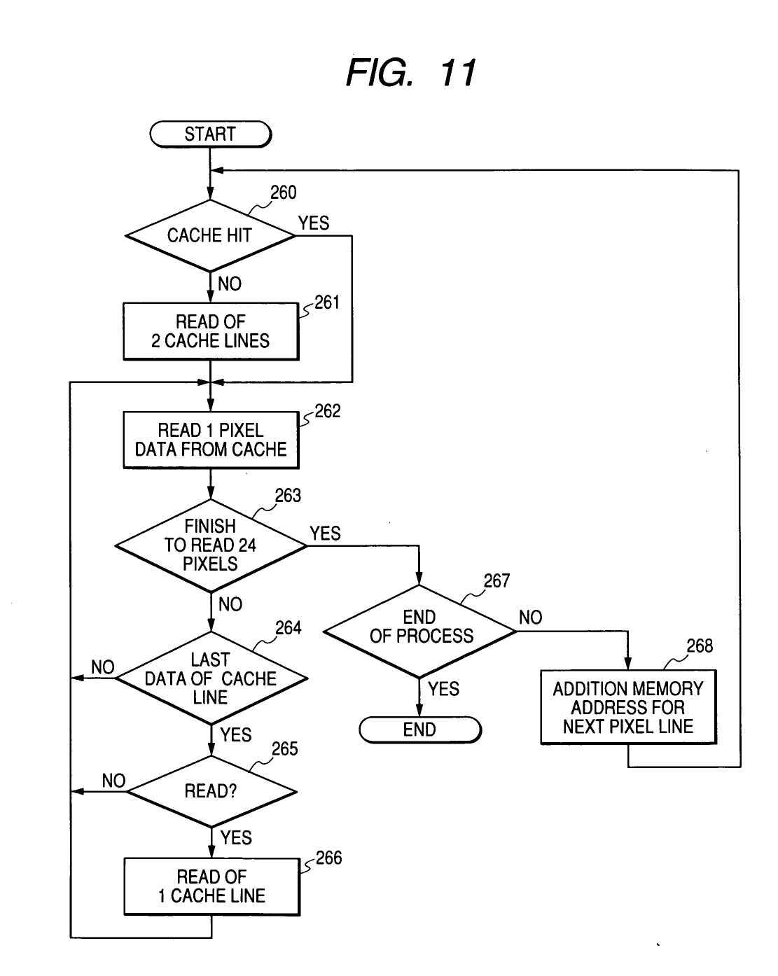

Next, a fifth embodiment of the invention in which frame memory accessing is made more efficient by reading into or writing out of caches line by line is shown in FIG. 10 and FIG. 11.

FIG. 10 shows one example of frame memory accessing method used in motion compensation, whereby the frame takes on a form (251) in which 17 pixels, vertical and horizontal, are taken out of the picture (250), and data in that 17-pixel portion is consecutively utilized. Writing into the cache (252) having two cache lines is performed line by line. Where there are eight bytes per line, reading out data of 17 pixels requires reading of 24 pixels on three lines (255, 256 and 257). Regarding reference pixel data groups in cache line units, the reference pixel data group 255 is written into the cache line 253, and the reference pixel data group 256 into the cache line 254. The reference pixel data group 257 is written into the cache line 253 as soon as it is vacated. The processor 1 has an area in which the number of times reading or writing consecutively takes place in cache line units (three times in the foregoing case) is stored, and performs reading or writing by utilizing information on the number of times stored in the area.

The actions performed in motion compensation for reading or writing eight pixels on one line three consecutive times will now be described with reference to FIG. 11. At the beginning of processing, it is checked whether or not the necessary reference pixel data has hit the cache 32 (260). If not, the first 16 bytes of two lines, i.e. an equivalent of 16 pixels, are written in (261) Then, an equivalent of one pixel is read out of the first cache 32 into the register of a processor core 200 (262). Whether or not the reading of an equivalent of two lines out to the register has ended (263), followed by a check-up as to whether or not the final data on the cache line has been accessed (264). In the case of the final data, it is checked whether or not any further writing is required (265) and, if required, one line is written in (266). If the reading of 24 pixels, equivalent to three lines, has been completed (263) the completion of macroblock data processing is checked (267) and, if not completed, the address to the next pixel line is added (268). If the final data was accessed at 264, data on the pertinent cache line will be invalidated. The writing at 266 is performed onto the cache line on which the data was invalidated at 264. These actions make it possible to automatically read the next data into a cache line having completed read-in and thereby to enable more effective use of the cache.

Although the final data access to a cache line invalidates the pertinent cache line to enable data to be read into the cache in the embodiment described above, a method by which a cache access completion flag is provided for each cache line and the cache access completion flag for the pertinent cache can be turned ON from the TLB controller according to the set conditions is also acceptable. The condition under which a cache access completion flag is turned ON may be set by using the cache control register. Conceivable conditions include, for instance, accessing of ail the data on a cache line at least once and accessing of the data at the n-th byte on a cache line, but any other appropriate setting method or set condition can be used as well.

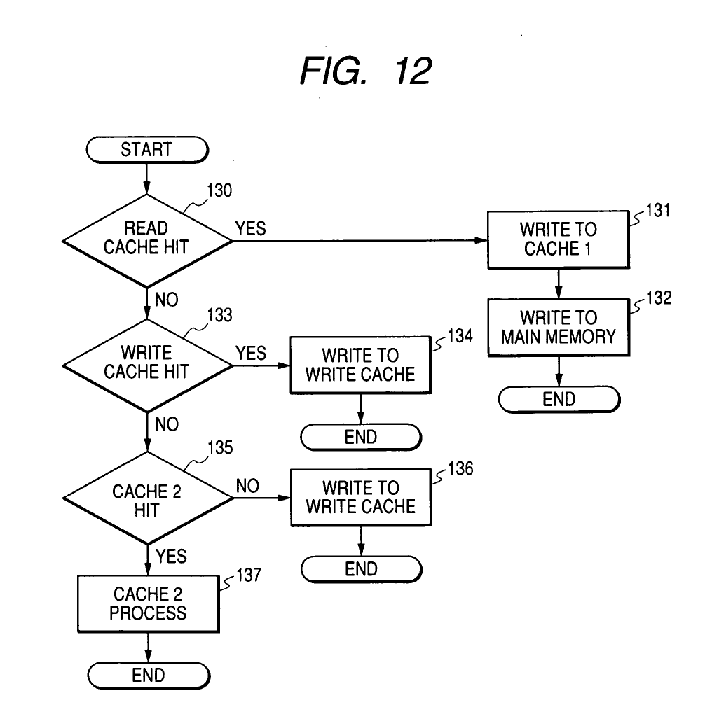

The sixth embodiment of the invention in which the first cache 32 is divided into an area for reading out to the processor 1 and an area for writing out of the processor 1 will now be described with reference to FIG. 12. FIG. 12 is a flow chart of a process in a case wherein the first cache 32 is divided into a read-out area (read-out cache) and a write-in area (write-in cache). In this embodiment, there is a cache area dedicated for writing data in. For this reason, it differs from the earlier embodiments only in the write-in operation.

In a write-in operation, first it is judged whether or not the read-out cache of the first cache 32 is hit (130). If it is hit, writing into the cache is performed (131) and, at the same time, writing into a memory is also performed (132). Or if the read-out cache is not hit, judgment as to whether or not the write-in cache will follow (133). If it is hit, writing into the write-in cache will be performed (134). If the read-out cache is not hit, judgment as to whether or not the second cache 6 is hit will follow (135). If it is hit, a second cache process will take place (137) or, if it is not hit, writing into the write-in cache of the first cache 32 will take place (136).

Although a case in which data is read out of and written into the first cache 32 was described with respect to the first through fifth embodiments of the invention, a case of writing through is also possible.

Further, the description of the foregoing embodiment limited itself to an MPEG decoding device, the configuration of using the first cache 32 and the second cache 6 according to the invention can also be applied to an MPEG encoding device.

According to the invention, the division of the cache device into the first cache area for storing picture data decoded in the past and the second cache area for storing header information and DCT coefficients serves to reduce the possibility for data read into the second cache area to be written back from the cache area to the main memory and alleviate the overhead of reading again out of the main memory, thereby making it possible to realize a faster and more efficient data processing device.

It is further understood by those skilled in the art that the foregoing description is a preferred embodiment of the disclosed device and that various changes and modifications may be made in the invention without departing from the spirit and scope thereof.

1. A data processing device comprising:
a main memory for storing data;
a central processing unit for accessing the main memory to execute data processing of MPEG encoding or decoding in accordance with an operation program; and
a cache device connected to the central processing unit to store a part of the data to be processed by the central processing unit,
where in the cache device has a first cache area for storing picture data decoded in the past and a second cache area, and
wherein the central processing unit, in accessing the cache device, performs selection of the first and second cache areas in accordance with relevant provision in the operation program.

2. The data processing device according to claim 1,
wherein the central processing unit reads reference pictures during the data processing of the MPEG encoding or decoding out of the first cache area.

3. The data processing device according to claim 1,
wherein header information is stored in the second cache area.

4. The data processing device according to claim 1,
wherein a DCT coefficient is stored in the second cache area.

5. The data processing device according to claim 1,
wherein the central processing unit performs the selection by using bits of an address set by the central processing unit.

6. The data processing device according to claim 1,
wherein the central processing unit has a register for storing a selection condition for the first and second cache areas and performs the selection according to the stored selection condition.

7. The data processing device according to claim 1,
wherein the central processing unit alters an instruction to be used according to a condition of the selection of the first and second cache areas, and performs the selection in accordance with the altered instruction.

8. The data processing device according to claim 1,
wherein the central processing unit alters a register to be used for storing the data according to a condition of the selection of the first and second cache areas, and performs the selection in accordance with the altered register to be used.

9. The data processing device according to claim 1,
wherein the central processing unit includes an area for storing a number of times for consecutively writing or reading in cache line unit of into or out of the cache device is performed, and
wherein the central processing unit, when the data can be stored in the cache device, reads or writes the data by using information on the number of times stored in the area.

10. The data processing device according to claim 1,
wherein the central processing unit has means of judging whether the data in the cache device in cache line units are valid or invalid, and stores the following data into the cache device on the basis of the resultant judgment.

11. The data processing device according to claim 1,
wherein the first cache area is divided into a read-out area and a write-in area.

12. A data processing device comprising:
a main memory for storing data;
a central processing unit for accessing the main memory to execute data processing in accordance with an operation program;
a first cache memory connected to the central processing unit to store a part of the data to be processed by the central processing unit;
a second cache memory connected to the central processing unit to store a part of the data to be processed by the central processing unit; and
a selector for recording the data in either of the first cache memory or second cache memory.

13. The data processing device according to claim 12, further comprising an instruction cache memory.

14. The data processing device according to claim 13,
wherein the selector has a first selector matching the first cache memory and a second selector matching the second cache memory,
wherein selection signal lines for inputting a selection signal are connected to the first and second selectors, and
wherein switching-over between a first state in which the first selector lets the data pass and the second selector does not let the data pass and a second state in which the first selector does not let the data pass and the second selector lets the data pass is accomplished with the selection signal.

15. The data processing device according to claim 14,
wherein complementary selection signals are inputted into the first selector and second selector.

16. The data processing device according to claim 15,
wherein the first cache memory stores picture data decoded in the past.
